(19) United States
(12) Patent Application Publication
(10) Pub. No.: US 2020/0314070 A1
(43) Pub. Date: Oct. 1, 2020

(54) OBSCURED MEDIA COMMUNICATION

(71) Applicant: PopSockets LLC, Boulder, CO (US)

(72) Inventors: David B. Barnett, Boulder, CO (US); Altan Nahum, Boulder, CO (US)

(21) Appl. No.: 16/832,257

(22) Filed: Mar. 27, 2020

Related U.S. Application Data
(60) Provisional application No. 62/826,424, filed on Mar. 29, 2019.

(51) Int. Cl. H04L 29/06; G10L 15/22; G10L 25/78; G06F 3/0488; G06F 11/14; G06F 16/11; G06F 21/60; G06F 21/62

(52) U.S. Cl. CPC H04L 63/0428; G10L 15/22; G10L 25/78; G06F 21/6218; G06F 11/1469; G06F 16/116; G06F 21/602; G06F 3/04883

(57) ABSTRACT

Portable computing devices, software operating on and stored in such devices, and methods are described herein that decrypt media in response to one or more input actions. The input actions can be measured or sensed by one or more components of the device. In some versions, a sender can cause a media file to be obscured and provide the one or more actions required to restore the obscured media file. The media file can be shared between client devices of a sender and receiver through messaging application software operating on the client devices.

### CROSS-REFERENCE TO RELATED APPLICATION

This application is related to U.S. Provisional Application No. 62/826,424, filed Mar. 29, 2019, which is hereby incorporated by reference herein in its entirety.

### FIELD OF THE DISCLOSURE

The present disclosure generally relates to software applications on a portable client device that implement components to receive user inputs.

### BACKGROUND

Client devices, including phones, tablets, e-readers, for example, are commonly used to transmit and receive media files. Specifically, media files can be transferred over communication networks through conventional or social media messaging applications. Further, many messaging applications include filters and effects that users can add graphical effects over the media files. The media files in conventional or social media messaging applications, however, may not allow a sender to encrypt or otherwise distort the media files before sending such that the media files cannot be immediately displayed or otherwise output on a recipient client device upon reception in their original forms.

### SUMMARY

In accordance with a first aspect, a method for restoring an obscured media file is disclosed that includes receiving an obscured form of a media file at a client device, determining one or more actions required to obtain a restored form of the media file with the client device, sensing or measuring activity with one or more components of the client device, determining whether the activity corresponds to the one or more actions, and outputting the restored form of the media file in response to determining that the activity corresponds to the one or more actions.

According to some forms, sensing or measuring the activity with the one or more components of the client device can include sensing or measuring activity with one or more of a user input, microphone, camera, accelerometer, gyroscope, magnetometer, or global positioning circuitry of the client device. In further forms, sensing or measuring the activity with the one or more components of the client device can include one or more of: receiving an audio input of a predetermined word or phrase at the microphone of the client device, measuring an amount of movement corresponding to a predetermined number of steps or a particular activity with at least one of the accelerometer or gyroscope of the client device, measuring a rotation of the portable electronic device with at least one of the accelerometer or gyroscope, receiving a manipulation input across a length of a touch screen of the client device or in a particular pattern, shape, or picture with the touch screen of the client device; receiving a manipulation input with a touch screen of the client device playing a particular game; capturing an image, series of images, or video of at least one of a particular item or activity with the camera of the client device; or determining that the client device is present at a particular location using the global positioning circuitry of the client device.

According to some forms, the method can include one or more of the following aspects: receiving one or more actions from a sender device; receiving a plurality of actions required to obtain the restored form of the media file and receiving a predetermined order in which the plurality of actions must be performed to obtain the restored form of the media file; receiving a distorted thumbnail of an image; displaying an animation of the obscured form of the media file transforming to the restored form of the media file; or displaying one or more effects added to the media file at the sender device.

In accordance with a second aspect, a method of sending an obscured media file is disclosed that includes receiving a selection of a media file at a user input of a client device, receiving a selection of a destination client device to receive the media file, receiving an input at the client device to create an obscured form of the media file, receiving data indicating one or more actions required to be measured or sensed by the destination client device to restore the obscured form of the media file, and receiving an input at the client device to send information related to the obscured form of the media file, the media file, and data indicating the one or more actions required to restore the encrypted obscured of the media file to the destination client device.

According to some forms, the method can include one or more of the following aspects: receiving data indicating at least one of: a predetermined word or phrase to be received at a microphone of the destination client device, an amount of movement corresponding to a predetermined number of steps or a particular activity to be measured by at least one of an accelerometer or a gyroscope of the destination client device, a rotation of the destination computing device to be measured by at least one of an accelerometer or a gyroscope of the destination client device, a manipulation to be input across a length of a touch screen of the destination client device, a manipulation to be input in a particular pattern, shape, or picture with the touch screen of the destination client device, a manipulation input with a touch screen of the client device playing a particular game an image, series of images, or video of at least one of a particular item or activity captured by a camera of the destination client device, or a determination that the client device is present at a particular location using global positioning circuitry of the destination client device; receiving data indicating a plurality of actions required to restore the obscured form of the media file and receiving data indicating an order in which the plurality of actions must be performed to restore the obscured form of the media file; receiving the input at the client device to create the obscured form of the media file can be receiving the data indicating the one or more actions required to be measured or sensed by the destination client device to restore the obscured form of the media file; creating the obscured form of the media file by creating a distorted thumbnail of an image with an algorithm operating on the client device; displaying an animation of the media file transforming to the distorted thumbnail of a display of the client device; or receiving one or more effects layered on the media file with an input of the client device and receiving an input at the client device to create an obscured form of the media file with the one or more effects.

In accordance with a third aspect, a non-transitory computer readable medium is disclosed herein that has instructions stored thereon that, in response to execution by a computing device, causes the computing device to perform operations that can include any one of the above methods.

In accordance with a fourth aspect, a client device having a processing device and a memory having executable instructions stored thereon is disclosed herein, where the processing device is configured to execute the instructions to perform any one of the above methods.

### BRIEF DESCRIPTION OF THE DRAWINCIS

The above needs are at least partially met through provision of the embodiments described in the following detailed description, particularly when studied in conjunction with the drawings, wherein:

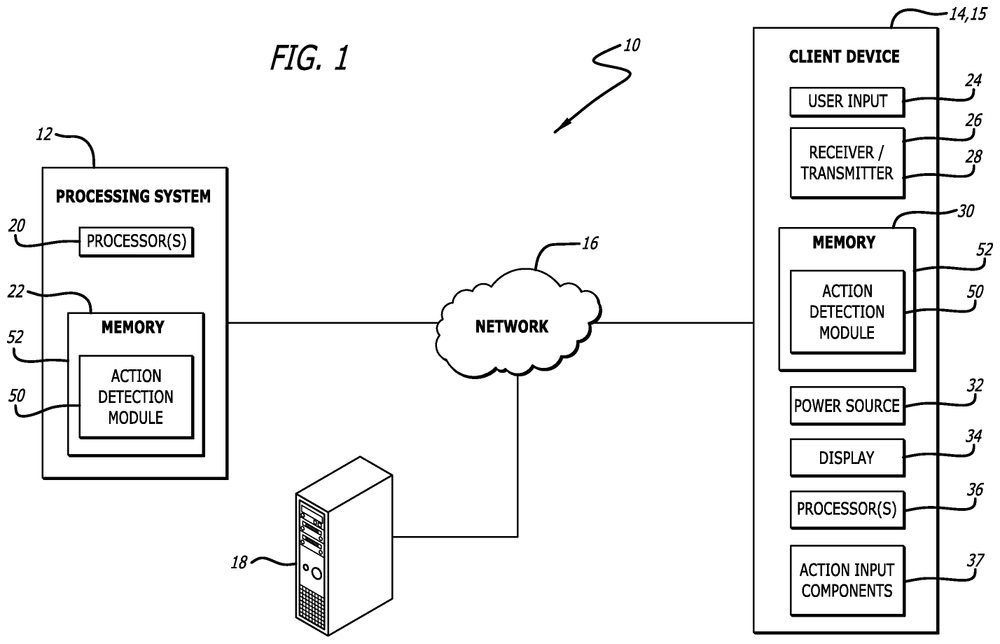

FIG. 1 is a block diagram of an example computing environment in which the techniques of this disclosure for obscuring and restoring media files can be implemented in accordance with various embodiments;

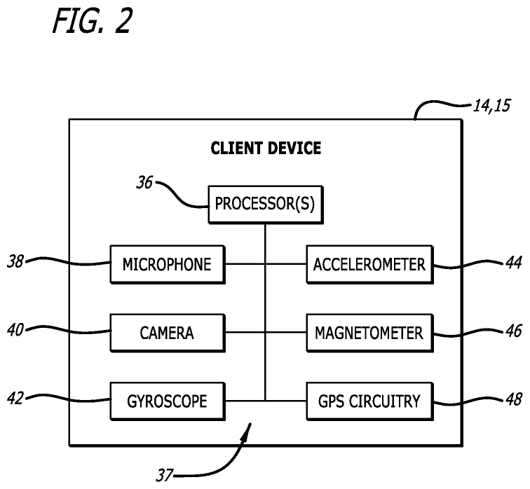

FIG. 2 is a block diagram of example client device with input components in accordance with various embodiments;

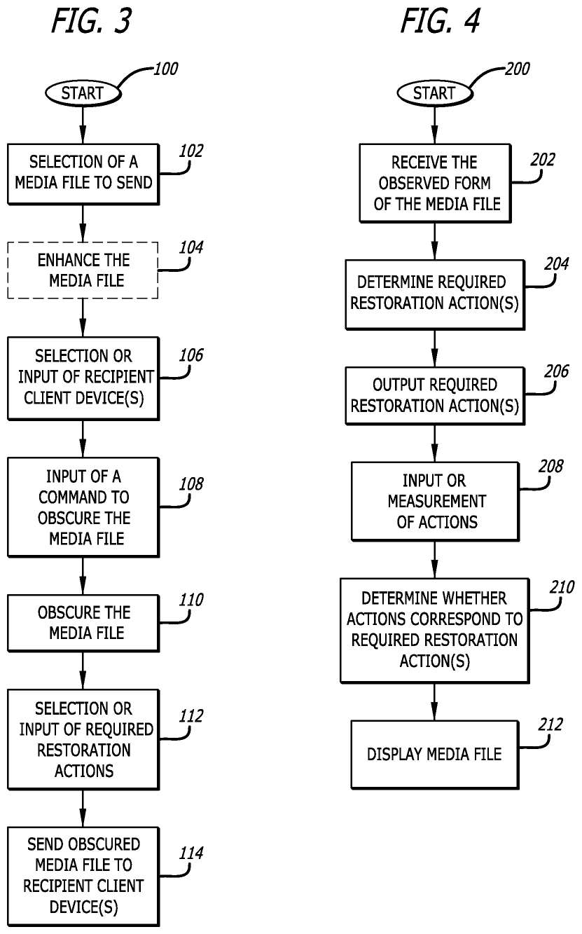

FIG. 3 is a flow chart for obscuring and sending a media file in accordance with various embodiments;

FIG. 4 is a flow chart for receiving and restoring a media file in accordance with various embodiments; and

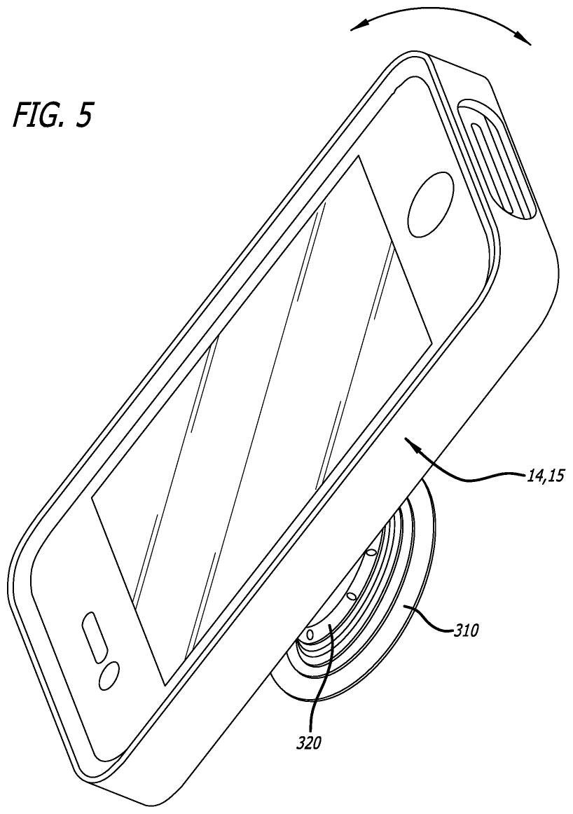

FIG. 5 is a schematic perspective view of a client device affixed with an expandable/collapsible grip accessory in accordance with various embodiments.

### DETAILED DESCRIPTION

Portable computing devices, software operating on and stored in such devices, and methods are described herein that obscure media in response to one or more input actions. The input actions can be measured or sensed by one or more components of the device, including, for example, an accelerometer, a gyroscope, a microphone, a touch screen, a camera, and so forth.

In some versions, a sender can cause a media file to be obscured and provide one or more actions required to restore the obscured media file. Obscuration of the media file can be based on an input from the sender, which can be measured or sensed by one or more components of the client device. In one form, the media file can be shared between client devices of a sender and receiver through messaging application software operating on the client devices.

The software described herein is particularly suitable for being implemented on a device affixed with a rotating accessory to enable users to easily rotate the device for input and media manipulation functionalities.

FIG. 1 illustrates one exemplary computing environment 10 in which techniques for sending and receiving obscured media files may be implemented. In the computing environment 10, a processing system 12 can communicate with various client devices (e.g., sender client device 14 and receiver client device 15), application servers, web servers, and other devices via a communication network 16, which can be any suitable network, such as the Internet, WiFi, radio, Bluetooth, NFC, etc. The processing system 12 includes one or more servers or other suitable computing devices. The communication network 16 can be a wide-area network (WAN) or a local-area network (LAN), for example, and can include wired and/or wireless communication links. A third-party server 18 can be any suitable computing device that provides web content, applications, storage, etc. to various client devices 14, 15. The content can include media, such as music, video, images, and so forth in any suitable file format. The methods and algorithms described herein can be implemented between the client devices 14, 15, using the processing system 12 and/or the third party server 18 as an intermediary, storage device, and/or processing location.

As illustrated in FIGS. 1 and 2, the processing system 12 can include one or more processing devices 20 and a memory 22. The memory 22 can include persistent and non-persistent components in any suitable configuration. If desired, these components can be distributed among multiple network nodes. The client devices 14, 15 can be any suitable portable computing devices, such as a mobile phone, tablet, E-reader, and so forth. The client device 14 can be configured as commonly understood to include a user input 24, such as a touch screen, keypad, switch device, voice command software, or the like, a receiver 26, a transmitter 28, a memory 30, a power source 32, which can be replaceable or rechargeable as desired, a display 34, and a processing device 36 controlling the operation thereof. As shown in FIG. 2, the client device 14, 15, in addition to the user input 24, also includes components or sensors 37 that can measure, sense, or receive actions or inputs from a user. For example, the client device 14, 15 can include a microphone 38, a camera device 40, a gyroscope 42, an accelerometer 44, a magnetometer 46, and global positioning system (GPS) circuitry 48. As commonly understood, the components 37 of the device 14, 15, as well as other electrical components, are connected by electrical pathways, such as wires, traces, circuit boards, and the like. The memory 30 can include persistent and non-persistent components.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein.

The components 37 of the client device 14, 15 can advantageously be utilized to input actions or to manipulate media as described herein. For example, the microphone 38 can be utilized by a user to input a command to the client device 14, 15 and/or input a spoken word or phrase to the client device 14, 15, while the camera device 40 can be utilized by a user to capture a particular image, series of images, and/or video. Additionally, the client device 14, 15 can operate image analysis software, either stored locally or operated remotely, to analyze the image, series of images, and/or video to detect a predetermined object or activity. For example, the image analysis software can be configured to detect an action, such as dancing, waving, clapping, performing particular exercises, including push-ups, jumping jacks, lunges, squats, etc., making funny faces with particular facial distortions, and so forth. The gyroscope 42 can measure an orientation and angular velocity of the client device 14, 15. The accelerometer 44 can measure a general rotation, an angular velocity, a rate of change, a direction of orientation and movement, and/or determine an orientation of the device 14, 15 in a three-dimensional space. In addition or an alternative to the above image analysis software, the gyroscope 42 and/or accelerometer 44 can provide measurements to the processing device 36 indicative of a particular action, such as dancing, waving, clapping, performing particular exercises, and so forth. The magnetometer 46 can be utilized to measure the direction of an ambient magnetic field to determine an orientation of the device 14, 15 and/or can be utilized as a metal detector. The GPS circuitry 48 can be configured to communicate with the satellite-based radionavigation system to obtain geolocation information for the device 14, 15.

Referring back to FIG. 1, the client device 14, 15 includes an action detection module 50 stored in the memory 30 as a set of instructions executable by the processing device 36. The action detection module 50 is configured to analyze measurements from or inputs to one or more of the components 24, 38, 40, 42, 44, 46, 48 of the device 14, 15 to identify predetermined triggering events. If desired, the functionality of the action detection module 50 also can be implemented as an action detection module application programming interface (API) 52 stored in the memory 30 that can include any content that may be suitable for the techniques of the current disclosure, which various applications executing on servers and/or client devices can invoke. For example, the API 52 may perform a corresponding action to obscure, modify, enhance, encrypt, restore or decrypt media on the client device 14, 15 in response to a detected action event of the client device 14, 15 detected by the action detection module 50. The action detection module 50, as set forth below, can invoke the API 52 when necessary, without having to send data to the processing system 12. In other versions, one or more steps of the below-described methods/algorithms can have cloud-based processing and/or storage and the processing system 12 can include an action detection module 50, configured as described with the above form, stored in the memory 30 as a set of instructions executable by the processing device 20.

Referring now to the flowchart shown in FIG. 3, a method and software algorithm 100 of preparing and sending an obscured media file is provided. In a first step 102, a sender selects a media file to send from the client device 14 to the receiver client device 15. The media file can be selected from the memory 30 of the client device 14 using the user input 24, captured with the camera device 40, or retrieved from the third-party server 18, for example. As noted above, this step can be carried out using cloud-based processing and/or storage. Moreover, as discussed above, the media file can be any suitable file, including, an image, a series of images, a gif, or a video. In alternative forms, the media file can be an audio file, a text file, a pdf file, and so forth.

After the media file is selected, in a second step 104, the sender can optionally enhance the media file by adding one or more effects to the media file in an interface provided by the application software. For example, an effect can insert layered text, stickers, graphics, such as emoticons, filters, animations, etc. to the media. In one version, a sender can add a message over the media, insert a graphic and/or filter, and so forth using the user input 24. It should be appreciated that the addition of such effects is distinct from the obscuration (e.g., encryption, distortion) operations described below that are intended to inhibit the ability of the recipient from viewing the original image data.

In a third step 106, the sender can select or input one or more receiver client devices 15 as a destination for the media file. Identification/contact information for the client devices 15 can be stored locally on the memory 30 of the client device 14 or retrieved from remote storage 22.

In a fourth step 108, the sender can input a command to the client device 14 to obscure the media file, with any added effects as mentioned above, if desired. The input can take any suitable form, including selection of a button on the user input 24, a flick or drag motion across the user input 24, drawing a predetermined shape, e.g., a circle, oval, square, or other polygons or curvilinear shapes, pattern, e.g., cross-hatching, a swirl, etc., or picture on the user input 24, moving the client device 14 in a predetermined fashion, such as shaking the device 14, rotating the device 14, moving the device in a circle, and so forth. In an alternative form, the input can be a series of actions measured by or input into one or more of the components 24, 38, 40, 42, 44, 46, 48 of the client device 14 including any of the examples set forth above.

Upon receiving the input, in a fifth step 110, the client device 14 can obscure the media file to create an obscured form thereof. In one form, the client device 14 can run an algorithm with the media file as an input. As mentioned above, this step can be a cloud-based process as well. In either case, the media file may be obscured by applying a cryptographic encryption function to the original image, thereby generated an encrypted form of the media file. The key applied by the cryptographic encryption may be based on the above sender input.

In another version, events (e.g., rotation, shaking, swiping, tapping, flicking, etc.) detected by the module 50 can cause the API 52 to obscure the media file by modifying or altering the image(s), gif, video, text, or other media by distorting according to a selected distortion effect, such as a spiral effect, a kaleidoscope effect, a pixilation effect, a stretching effect, a warp effect, a twist effect, a rotated color map effect, a dynamic flash effect, a transition effect, such as fade, warp, twist, etc., an audio distortion effect applied to a music file or audio portion of any file type, such as changing the volume, frequency, playback speed, adding sounds/noises, playing in reverse, etc., and/or an image specific effect. Other distortion effects are within the scope of the disclosure. The distortion can be achieved by the user twisting the device 14 and/or spinning the client device 14 one of clockwise or counterclockwise. If desired, the user can stop the distortion by stopping the rotation or other action associated with the device 14 or selection of the user input 24. By another approach, the speed of the spin can be utilized to control an amount of the distortion, or any other characteristic of the distortion. Rotational characteristics, such as spin direction, spin speed, spin rate of change, and the like, can further factor into the selection of the one or more manipulation operations. The application software can operate during rotation of the device 14 to stabilize the media file to have a consistent orientation while the device 14 spins. Inserted material can be added either prior to or after a distortion effect. By a further approach, the file can be saved as a video, of any suitable moving image file format, such as .avi, .flv, .wmv, .mp4, .mov, a .gif, or other suitable file formats, transitioning between the original version and the distorted version of the image as a thumbnail of the obscured media file. The thumbnail of the obscured media file can be sent to the receiver client device 15, particularly in instances where the media file includes one or more images or a video. For example, the algorithm can sequentially output status images of the distortion of the media file to thereby display an animation of the distortion of the media file on the client device 14 until the distorted/encrypted thumbnail of the media file is formed. In other examples, the algorithm can create video or gif files to display on the client device 14.

In a sixth step 112, the sender can input or select one or more actions required to be sensed by or input into the receiver client device 15 in order for the application operating on the device 15 to restore (e.g., decrypt) the obscured form of the media file. For example, the sender can select one or more desired restoration actions from a list displayed on the device display 34 provided by the application software. The selected actions can include user input fields or alterable values. In another example, the sender can provide an action input to the client device 14 by performing the required restoration action(s).

A required restoration action can be any data measured or sensed by a component/sensor of the destination client device 15. In some examples, the required restoration action(s) can be a predetermined word or phrase to be received at the microphone 38 of the device 15; a picture or video, which can be of a particular item or activity, captured by the camera 40 of the device 15 and identified with image analysis software, an amount of movement corresponding to a predetermined number of steps or particular activity, which can be set within a predetermined time period, to be measured by the accelerometer 44 of the device 15; an orientation of the device 15 measured by the accelerometer 44, gyroscope 46, and/or magnetometer 46, a rotation or movement of the device 15 to be measured by the accelerometer 44 and/or gyroscope 46 of the device 15; a manipulation to be input across a length of a touch screen 24 of the device 15 or in a particular pattern or shape; a determination that the device 15 is present at a particular location using the GPS circuitry 48 of the device, or combinations thereof, to name a few.

In other or additional versions, the required restoration action can be an input using the user input 24 of the device 15. For example, the required restoration action can be a selection of a button on the user input 24 or a flick or drag motion across the user input 24 in a straight or curved line, which can have a predetermined length if desired. Additionally, in some forms, the user can specify an angled orientation and/or direction of the line. In other examples, the required restoration action can be drawing a shape, e.g., a circle, oval, square, or other polygons or curvilinear shapes, drawing a pattern, e.g., cross-hatching, a swirl, etc., or drawing a picture on the user input 24. Using this functionality, the user can input a desired straight/curved line, shape, pattern, or drawing using the user input 24 or can select a desired straight/curved line, shape, pattern, or drawing from a list of available options using the user input 24. Using this functionality, for example, the user can draw a picture, pattern, or shape using the user input 24 that the receiving user will be required to draw using the device 15 in order for the application operating on the device 15 to decrypt the encrypted form of the media file.

In other or additional versions, the required restoration action can be the completion of a game selected by the user of the sending device 14 using the user input 24. For example, the application can provide a plurality of available games, which can include puzzles, crosswords, mazes, trivia, arcade games, shooting games, side scrolling games, and so forth. If desired, the games may have user-selectable difficulties, such as easy, medium, and hard. Using this functionality, for example, the user can select a desired game using the user input 24 that the receiving user will be required to play and, if desired, beat or solve using the receiver client device 15 in order for the application operating on the device 15 to decrypt the encrypted form of the media file. As noted above, an amount of movement corresponding to a particular activity or orientation may be used as the required restoration action, which may include:
Motions or particular orientations of the device 15, such as a spin, flick, rotational gesture, step counter, number of rotation per-minute, laying the device upright, flat, or a particular orientation with respect to Earth's magnetic field. The speed or other movement of the viewing device, such as its speed of travel, may also be identified. For example, a motion may be associated with an instruction to the viewing user to “lay your device down and pointing to the north” or “travel 25 miles per hour.” This condition may then be determined from gyroscope and/or magnetometer sensor data (e.g., using gyroscope 42 and/or magnetometer 46).
Geolocation based on the GPS circuitry 48, such as the device 15 being within a particular geofence, at a particular type of location (by referencing map data), a particular name of a location or within a distance from a specified location. For example, the required restoration action may be for the viewing user to take the device to within the displayed geofence or take the device to an airport.
User gestures detected by the device 15, as noted above, such as waving or performing a dance move, or applying an audio distortion effect to music or audio, as noted above, including changing volume, frequency, playback speed, adding sounds/noises, playing in reverse, etc. These may be detected by the aforementioned accelerometer 44, gyroscope 46, and/or magnetometer 46 of the device 15.
Visual characteristics in the environment of the device 15 captured, as noted above using the camera of the device 15, which may include color or brightness or objects present in a captured image or video by an imaging sensor. For example, captured images may be analyzed to determine whether it contains a given color or is within a light or dark room. Likewise, objects or expressions (e.g., on a face) may be detected with a set of object detection algorithms and machine-learned classifiers. These visual characteristics may be associated with a required restoration action, such as “show a smiling face,” “take a picture of two dogs” or “take a picture of a cloudy sky.”
Sounds, words, or phrases, which may be detected by an audio sensor. These may be based on volume or frequency of input sound, or may be further processed to detect characteristics of the detected audio. For example, the audio may be processed by a speech-to-text algorithm that generates detected words or syllables in the audio. For example, sound input may be associated with an instruction to the viewing user to “make a loud sound” or “snap your fingers.”
A combination of these conditions, such as a user running 100 yards in less than 15 seconds, then jumping up in the air with arms outstretched while saying “I'm the winner!” The device may detect movement that corresponds to running and listen for audio that is recognized as “I'm the winner!”

Of course, in addition to all of the examples described herein, it will be understood that other data measured, sensed, or input to the components 24, 38, 40, 42, 44, 46, 48 can also or alternatively be used as a required restoration action and is within the scope of the present disclosure.

In some versions, the sender can input or select a plurality of actions that are required to restore/decrypt the obscrued form of the media file. Moreover, if desired, the sender can also indicate a predetermined order that the required restoration actions must be performed by the receiver to restore the obscured form of the media file. In one example, the fourth step 108 input(s) to obscure/encrypt the media file can be the action or series of actions required to be sensed by or input into the receiver client device 15 in order for the application operating on the device 15 to decrypt the encrypted form of the media file.

Thereafter, in a seventh step 114, the sender causes the obscured form of the media file to be sent to the selected receiver device(s) 15 by selection of a corresponding prompt provided in the application software using the user input 24. The application software operating on the client device 14 then compiles the original media file along with any effects added, the obscured form of the media file, and data indicating the one or more restoration actions required to restore the obscured form of the media file and sends the data to the destination client device 15, the processing system 12, and/or the third party server 18. As noted above, this step can be carried out using cloud-based processing and/or storage. It will be understood that while the flowchart shown in FIG. 3 illustrates one order for the steps of the method and algorithm 100 to be performed, certain ones of the steps can be reordered within the method and algorithm and still be within the scope of the disclosure.

Referring now to a flowchart as shown in FIG. 4, a method and software algorithm 200 of receiving and restoring a media file is provided. In a first step 202, the receiver client device 15 receives at least the obscured form of the media file (e.g., encrypted or distorted) over the communication network 16. As discussed above, in one form, the client device 15 can display the distorted thumbnail of the media file. In a second step 204, the client device 15 can determine one or more actions required to obtain the restored form of the media file. For example, the application software operating on the client device 15 can retrieve the actions stored locally on the memory 30 or stored remotely at the third-party server 18. In another example, as discussed above, the client device 15 can receive the actions along with the obscured of the media file as input by the sender into the sender client device 14. Further, if the sender, or the application software, provided an order in which the actions be performed, the client device 15 can receive or retrieve the predetermined order.

In a third step 206, the client device 15 can output, such as on the display 34 and/or a speaker, the required restoration actions to restore the obscured form of the media file and, if applicable, a required order. Thereafter, in a fourth step 208, the receiving party can perform the required restoration action(s), which are input or sensed by the components 24, 38, 40, 42, 44, 46, 48 of the client device 15, examples of which actions are described above. Upon input or sensing of an action by one or more of the components 24, 38, 40, 42, 44, 46, 48, in a fifth step 210, the processing device 36 can determine whether the action corresponds to an action required to restore the media file and, if applicable, the action corresponds to a next action in a series of actions required to restore the media file.

In a sixth step 212, in response to determining that the receiving party has performed the required restoration action(s) and, if applicable, in the required order, the application software operating on the client device 15 can cause the original media file to be displayed or output. In one version, the application software operating on the client device 15 can retrieve the original media file and run the distortion/cryptographic algorithm backward. Running backward, the algorithm reverses the distortion/encryption of the media file to arrive at the original media file. The algorithm can sequentially output status images of the media file as the distortion/encryption is sequentially removed to thereby display an animation of the restoration of the distorted thumbnail on the client device 15 until the media file is displayed. In other examples, the algorithm can create video or gif files to display on the client device 15. As discussed above, the original media file can be displayed with any effects added by the sender. It will be understood that while the flowchart shown in FIG. 4 illustrates one order for the steps of the method and algorithm 200 to be performed, certain ones of the steps can be reordered within the method and algorithm and still be within the scope of the disclosure.

For many approaches, some of the functionalities described herein can be achieved by a user twisting the client device 14, 15 in a hand, spinning the client device 14, 15 on a surface, and so forth. To further enable a user to easily rotate, spin, and manipulate the rotation of the client device 14, 15, the device 14, 15 may be affixed with an expandable/collapsible grip accessory 310, as illustrated in FIG. 5. FIG. 5 schematically illustrates a client device 14, 15 affixed with a grip accessory 310. The grip accessory 310 of FIG. 5 may include a rotating portion 320, which can include bearings, low-friction couplings, etc., that allows the client device 14, 15 to spin freely relative to the remainder of the grip accessory 310, when the grip accessory 310 is held in a user's hand or placed on a surface, for example. In some instances, the grip accessory 310 of the current disclosure may include, at least in part, an extending grip accessory for a portable media player or portable media player case as disclosed in U.S. Pat. No. 8,560,031, or U.S. Publication No. 2018/0288204, entitled “Spinning Accessory for a Mobile Electronic Device,” the entire disclosures of which are incorporated herein by reference.

The application software described herein can be available for purchase and/or download from a website, online store, or vendor over the communication network 16. Alternatively, a user can download the application onto a personal computer and transfer the application to the client device 14, 15. When operation is desired, the user runs the application on the client device 14, 15 by a suitable selection through the user input 24.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method for restoring an obscured media file, the method comprising:
receiving an obscured form of a media file at a client device;
determining one or more restoration actions required to obtain a restored form of the media file with the client device;
sensing or measuring an activity with one or more components of the client device;
determining whether the activity corresponds to the one or more restoration actions; and
outputting the restored form of the media file in response to determining that the activity corresponds to the one or more restoration actions.

2. The method of claim 1, wherein sensing or measuring the activity with the one or more components of the client device comprises sensing or measuring the activity with one or more of a user input, microphone, camera, accelerometer, gyroscope, magnetometer, or global positioning circuitry of the client device.

3. The method of claim 2, wherein sensing or measuring the activity with the one or more components of the client device comprises receiving an audio input of a predetermined word or phrase at the microphone of the client device.

4. The method of claim 2, wherein sensing or measuring the activity with the one or more components of the client device comprises measuring an amount of rotation or movement corresponding to a predetermined number of steps or a particular activity with at least one of the accelerometer or gyroscope of the client device.

5. The method of claim 2, wherein sensing or measuring the activity with the one or more components of the client device comprises receiving a manipulation input: across a length of a touch screen of the client device; or in a particular pattern, shape, or picture with the touch screen of the client device.

6. The method of claim 2, wherein sensing or measuring the activity with the one or more components of the client device comprises receiving a manipulation input with a touch screen of the client device playing a particular game.

7. The method of claim 2, wherein sensing or measuring the activity with the one or more components of the client device comprises capturing an image, series of images, or video of at least one of a particular item or activity with the camera of the client device.

8. The method of claim 2, wherein sensing or measuring the activity with the one or more components of the client device comprises determining that the client device is present at a particular location using the global positioning system circuitry of the client device.

9. The method of claim 1, wherein determining the one or more actions required to obtain the obscured form of the media file comprises receiving one or more actions from a sender device.

10. The method of claim 9, wherein receiving the one or more actions comprises:
receiving a plurality of actions required to obtain the restored form of the media file; and
receiving a predetermined order in which the plurality of actions must be performed to obtain the restored form of the media file.

11. The method of claim 1, wherein receiving the obscured form of the media file comprises receiving a distorted thumbnail of an image.

12. The method of claim 1, wherein outputting the obscured form of the media file comprises displaying an animation of the obscured form of the media file transforming to the restored form of the media file.

13. The method of claim 1, wherein the obscured form of the media file comprises an encrypted form of the media file, and wherein the restored form of the media file comprises a decrypted form of the media file.

14. The method of claim 1, wherein the obscured form of the media file comprises a visually distorted form of the media file, and wherein the restored form of the media file comprises a visually restored form of the media file.

15. A method of sending an obscured media file, the method comprising:
receiving a selection of a media file at a user input of a client device;
receiving a selection of a destination client device to receive the media file;
receiving an input at the client device to create an obscured form of the media file;
receiving data indicating one or more actions required to be measured or sensed by the destination client device to restore the obscured form of the media file; and
receiving an input at the client device to send information related to the obscured form of the media file, the media file, and data indicating the one or more actions required to restore the obscured form of the media file to the destination client device.

16. The method of claim 15, wherein receiving the data indicating the one or more actions required to restore the obscured form of the media file comprises receiving data indicating at least one of: a predetermined word or phrase to be received at a microphone of the destination client device; an amount of movement corresponding to a predetermined number of steps or a particular activity to be measured by at least one of an accelerometer or a gyroscope of the destination client device; a rotation of the destination computing device to be measured by at least one of an accelerometer or a gyroscope of the destination client device; a manipulation to be input across a length of a touch screen of the destination client device; a manipulation to be input in a particular pattern, shape, or picture with the touch screen of the destination client device; a manipulation input with a touch screen of the client device playing a particular game; an image, series of images, or video of at least one of a particular item or activity captured by a camera of the destination client device; or a determination that the client device is present at a particular location using global positioning circuitry of the destination client device.

17. The method of claim 15, wherein receiving the data indicating the one or more actions required to restore the obscured form of the media file comprises:
receiving data indicating a plurality of actions required to restore the obscured form of the media file; and
receiving data indicating an order in which the plurality of actions must be performed to restore the obscured form of the media file.

18. The method of claim 15, wherein receiving the input at the client device to create the obscured form of the media file comprises receiving the data indicating the one or more actions required to be measured or sensed by the destination client device to restore the obscured form of the media file.

19. The method of claim 15, further comprising creating the obscured form of the media file by creating a distorted thumbnail of an image with an algorithm operating on the client device.

20. The method of claim 19, wherein creating the distorted thumbnail of the image comprises displaying an animation of the media file transforming to the distorted thumbnail on a display of the client device.

21. The method of claim 15, wherein the obscured form of the media file comprises an encrypted form of the media file, and wherein the one or more actions required to restore the obscured form of the media file comprises one or more actions required to decrypt the encrypted form of the media file.

22. A non-transitory computer readable medium having instructions stored thereon that, in response to execution by a computing device, cause the computing device to:
restore a received encrypted media file by:
determining one or more actions required to obtain a restored form of the media file;
sensing or measuring activity with one or more components;
determining whether the activity corresponds to the one or more actions; and
outputting the restored form of the media file in response to determining that the activity corresponds to the one or more actions;
send an obscured media file by:
receiving a selection of a media file;
receiving a selection of a destination client device to receive the media file;
receiving an input to create an obscured form of the media file;
receiving data indicating one or more actions required to be measured or sensed by the destination client device to restore the obscured form of the media file;
receiving an input to send information related to the obscured form of the media file, the media file, and data indicating the one or more actions required to restore the obscured form of the media file to the destination client device.

23. The non-transitory computer readable medium of claim 22, wherein sensing or measuring the activity with the one or more components comprises sensing or measuring activity with one or more of a user input, microphone, camera, accelerometer, gyroscope, magnetometer, or global positioning circuitry.

24. The non-transitory computer readable medium of claim 22, wherein determining the one or more actions required to obtain the restored form of the media file comprises receiving one or more actions from a sender client device.

25. The non-transitory computer readable medium of claim 24, wherein determining the one or more actions comprises:
determining a plurality of actions required to obtain the restored form of the media file; and
determining a predetermined order in which the plurality of actions must be performed to obtain the restored form of the media file.

26. The non-transitory computer readable medium of claim 22, wherein outputting the restored form of the media file comprises displaying an animation of the obscured form of the media file transforming to the restored form of the media file.

27. The non-transitory computer readable medium of claim 22, wherein the obscured form of the media file comprises an encrypted form of the media file, and wherein the restored form of the media file comprises a decrypted form of the media file.

28. The non-transitory computer readable medium of claim 22, wherein receiving the data indicating the one or more actions required to restore the obscured form of the media file comprises receiving data indicating at least one of: a predetermined word or phrase to be received at a microphone; an amount of movement corresponding to a predetermined number of steps or a particular activity to be measured by at least one of an accelerometer or a gyroscope; a rotation to be measured by at least one of an accelerometer or a gyroscope; a manipulation to be input across a length of a touch screen; a manipulation to be input in a particular pattern, shape, or picture with the touch screen; a manipulation input with a touch screen of the client device playing a particular game; an image, series of images, or video of at least one of a particular item or activity captured by a camera; or a determination of being at a particular location using global positioning circuitry.

29. The non-transitory computer readable medium of claim 22, wherein receiving the data indicating the one or more actions required to restore the obscured form of the media file comprises:
receiving data indicating a plurality of actions required to restore the obscured form of the media file; and
receiving data indicating an order in which the plurality of actions must be performed to restore the obscured form of the media file.

30. The non-transitory computer readable medium of claim 22, wherein receiving the input to create the obscured form of the media file comprises receiving the data indicating the one or more actions required to be measured or sensed by the destination client device to restore the obscured form of the media file.

31. The non-transitory computer readable medium of claim 22, further comprising creating the obscured form of the media file by creating a distorted thumbnail of an image.

32. The non-transitory computer readable medium of claim 31, wherein creating the distorted thumbnail of the image comprises displaying an animation of the media file transforming to the distorted thumbnail on a display.
